(19) United States
(12) Patent Application Publication
(10) Pub. No.: US 2007/0053338 A1
(43) Pub. Date: Mar. 8, 2007

(54) Apparatus, system and method capable of cooperating in a distributed communication wireless network

(76) Inventors: Sumeet Sandhu, San Jose, CA (US); Mark D. Yarvis, Portland, OR (US); Xintian Eddie Lin, Mountain View, CA (US); Prasanna G. Mulgaonkar, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/218,676

(22) Filed: Sep. 2, 2005

(51) Int. Cl. H04J 3/24

(52) U.S. Cl. 370/349

(57) ABSTRACT

An embodiment of the present invention provides an apparatus, comprising a node capable of cooperating in a distributed communication wireless network and wherein the cooperation is based upon predetermined fairness criteria. In an embodiment of the present invention the predetermined fairness criteria may include algorithms that account for battery life and quality of service (QoS). The wireless network may be a centralized network or de-centralized network.

### BACKGROUND

Wireless communications, including wireless networks, have become pervasive throughout society. Improvements in wireless communications are vital to increase their reliability and speed. Mesh networks are an example of wireless networks that may provide distributed communication and are in there infancy in development. Most commercial mesh networks may be infrastructure based, where base stations cooperate with each other. In this case, all cooperating nodes belong to the same entity such as the service provider and there is no issue of fairness or battery life. However, billing issues are a larger concern for client based cooperation where independent entities must cooperate.

Thus, a strong need exists for an apparatus, system and method capable of cooperating in a distributed communication wireless network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the process used by each node to decide whether to process a relay packet or not of one embodiment of the present invention;

FIG. 2 illustrates tiered service plans for different degrees of cooperation in distributed communication of one embodiment of the present invention;

FIG. 3 illustrates enforcement of a service plan which rewards cooperation in one embodiment of the present invention; and

FIG. 4 illustrates accounting for the number of times a node cooperates in one embodiment of the present invention;

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

An algorithm or process is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause and effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

An embodiment of the present invention provides methods for encouraging cooperation in a distributed communication wireless network. Distributed communication refers to any form of cooperation by spatially distributed third-party nodes that perform extra signal processing to assist in the packet exchange between a source-destination pair in a wireless network. Although the present invention is not limited in this respect, some examples of distributed communication are multi-hop relaying of packets from source to destination by independent nodes in a mesh network and virtual MIMO where neighboring nodes coordinate and transmit simultaneously in the fashion of a virtual antenna array between a source and destination.

In general, distributed communication requires third-party nodes to receive and transmit packets not intended for them. Cooperative communication by ensembles of spatially distributed nodes provides performance gains in terms of range, throughput, and quality of service (QoS) because it provides diversity against fading, shadowing and path-loss (as compared to a simple point-to-point link). Averaged over time-varying channel realizations and node locations, all point-to-point links between source-destination pairs enjoy a net performance gain from cooperation by third-party nodes. Since there is a net performance increase, it is generally in everyone's interest to support distributed communication.

There are several real and perceived challenges in enabling cooperation which include, but are not limited to:

(1) Battery Life

a. There is very little incentive for nodes to spend power on packets not directly intended for them.

b. In particular, mobile nodes such as cell-phones have limited battery life that must be saved for their own needs.

(2) Quality of Service

a. Nodes may suffer throughput losses for their own data if they spend bandwidth relaying others' packets.

(3) Security

a. Third-party nodes must receive and read packets intended for someone else, which may pose a security risk.

Of these challenges, security is a higher layer application that sits above the network layer. Distributed communication operates at lower layers and only requires packet headers at the physical, medium access and network layers. These headers are usually publicly readable in most wireless networks. Distributed communication therefore does not pose any unusual security risks beyond those currently encountered in wireless networks.

On the other hand, battery life and QoS are significant challenges. The hard question is how to drive independent nodes to cooperate as much as possible. Thus, is provided in the present invention, two different cases: centralized networks where infrastructure nodes cooperate and de-centralized networks where independently billed clients cooperate.

(A) Centralized Networks: Distributed Algorithms for Fairness

The best aggregate network performance may be achieved if all nodes agree to cooperate all the time. This leads to the service provider model, where all nodes are designed to cooperate all the time. This is easiest to implement in centralized networks that are controlled by single entities, e.g. wireless service providers. Examples include, but are not limited to, infrastructure base stations, access points, and sensor networks. Although nodes can be easily driven to cooperate all the time, it is important to allow for fairness. An embodiment of the present invention provides that cooperation should take place based on distributed processes that may account for battery life and QoS—although it is understood that the present invention is not limited to these criteria.

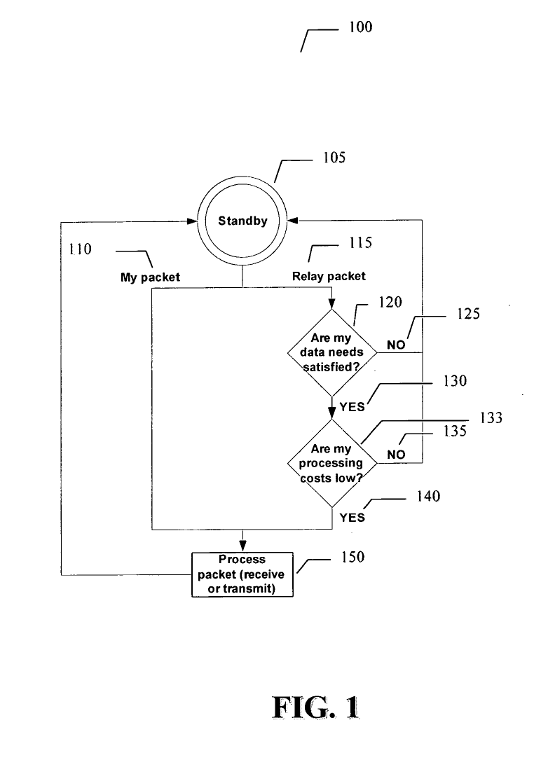

Turning now to the figures, in FIG. 1, shown generally as 100, is an embodiment of one such a process; Starting in standby 105, when a node receives a packet for relaying 115, it first checks whether its own data needs are met 120. If no, at 125 the process returns to standby 105. Data needs can be measured by various common metrics, e.g. the length of the application layer packet queue. If the node doesn't have outstanding packets 130, it then checks its processing costs 133. Processing costs can be measured by a number of metrics, for example, but not limited to remaining battery power and if too high, at 135 the process returns to standby 105. In this example, if there is sufficient battery life 140 (greater than a switching threshold that can be pre-determined by the equipment vendor or the service provider), the node then transmits the relay packet 150. This procedure can also be applied when the node receives the header on a relay packet, and wishes to make a decision on whether to receive the full packet or not. After standby 105, if the packet is considered to be my packet 110, it proceeds directly to 150 for reception or transmission.

(B) De-Centralized Networks: Billing for Incentive

The process proposed in FIG. 1 can also be implemented in commercial networks where nodes are independently billed. It would be advantageous, although the present invention is not limited in this respect, in an embodiment of the present invention to provide that switching thresholds be based on data needs and processing costs should be standardized to ensure fairness across different service providers and vendors.

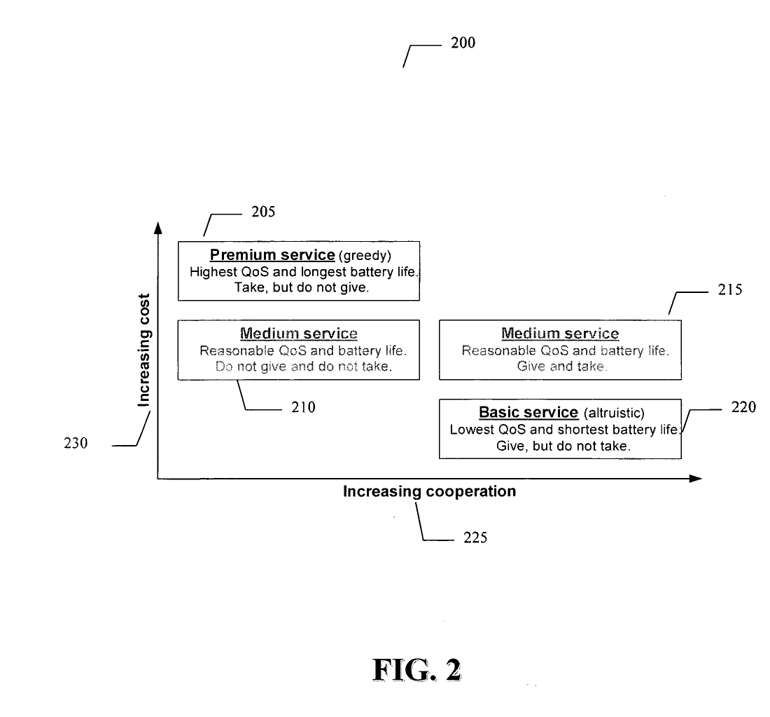

If these thresholds are not standardized, there will be significant challenges to ensuring cooperation. Some nodes may choose to never cooperate, especially if they are battery powered mobile nodes. Others may remain in sleep mode or powered down most of the time, only waking up to send their own packets. For this scenario, as shown generally at 200 of FIG. 2, an embodiment of the present invention provides novel billing methods that reward nodes for spending battery power to assist other nodes. The graph of FIG. 2 depicts increasing cost 230 vs. increasing cooperation 225. Further, periodic (e.g. monthly) billing may be performed, although not limited to these methods, by one of the following methods (or some combination thereof):

(1) Tiered Service Plan

a. Nodes that cooperate with others but do not request cooperation will pay the lowest basic rate 220.

b. Nodes that do not request cooperation and do not cooperate will be charged a medium rate higher than basic 215. Nodes that cooperate and request cooperation will also be charged the medium rate 210.

c. Nodes that request cooperation but do not cooperate will be charged the highest premium rate 205.

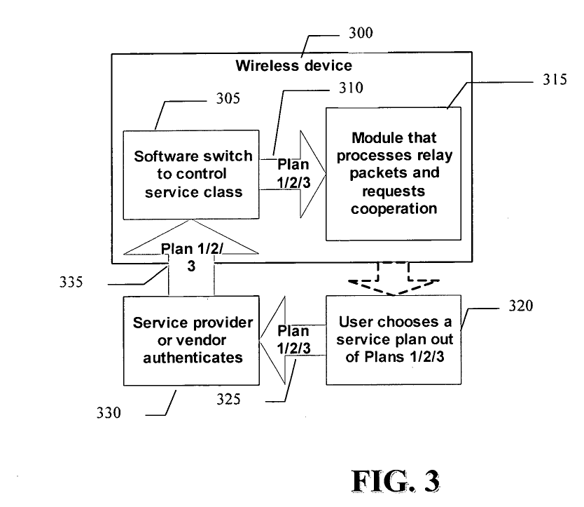

This plan is enforced by the vendor or service provider by means of a software switch or activation code (similar to the activation process for cell phones)—although the present invention is not limited in this respect. It may be provided that the user does not have control over the device hardware to change the setting. This is illustrated in FIG. 3. The new components that must be added to existing wireless devices 300 are the software switch to control services 305 and a component where a user chooses a service plan 320. At 320 a User chooses a service plan 325 and then a service provider or vendor authenticates the plan at 330. Plan 335 is then provided to the software switch to control services 305 and the output plan 310 of which is sent to a module that processes relay packets and requests cooperation 315.

(2) Usage Based Incentives

a. Nodes that relay the most packets for other nodes receive cash back at the end of the billing period.

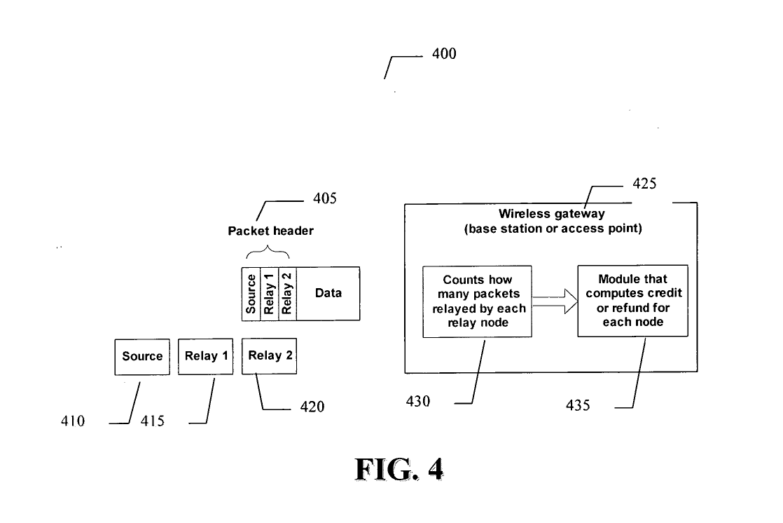

This encourages good citizenship. In extreme cases, this may encourage infrastructure-powered nodes to remain plugged in all the time, providing flexible network access at hotspots or sparsely serviced areas. In an embodiment of the present invention, this may be implemented by having the final destination gateway (e.g. base station or access point) keep track of all relaying addresses when it eventually receives the packet. This requires a new packet design, where the header contains addresses of all relays in the path from source to gateway. This also requires a new mechanism in each relay to add the relay address to the header of each forwarded packet and a new mechanism in the gateway that keeps track of number of packets relayed by each node. This is illustrated in FIG. 4, generally at 400. The new packer header 405 is supported in the Source 410, Relay 1 415, relay 2 420 and the wireless gateway 425. The wireless gateway 425, which may include, but is not limited to, a base station or access point, includes a module 430 to count how many packets are relayed by each relay module and passes that to a module 435 that computes credit or refund for each node.

(3) Usage Based Points/Credits

a. Nodes that relay packets for other nodes receive credit points per packet. When they ask other nodes to help them, they can choose to spend their credit points. This would be implemented in a manner similar to FIG. 4, where the local wireless gateway keeps track of packets relayed by each node. The credit points may be easier to manage than billing as the local gateway may keep track of local points earned and spent by each node, as collaborators are likely to be within the service area of the same gateway. Billing has to be conveyed to billing centers at some remote hub of the larger network.

An embodiment of the present invention thus provides that the basic premise underlying these billing plans may be that nodes that cooperate with others are spending valuable battery life and deserve reimbursement in the form of reduced costs. Nodes which are assisted by other nodes will enjoy the highest QoS and service levels, and should pay accordingly. In general, decisions to cooperate should be based on data needs and available power, as described above.

An embodiment of the present invention also provides a method of node cooperation in a distributed communication wireless network, comprising basing cooperation by nodes in the distributed communication wireless network upon predetermined fairness criteria, which may include battery life and quality of service (QoS). The wireless network may be a centralized network or de-centralized wireless network. This method may further comprise checking first whether its own data needs are met and if the node doesn't have outstanding packets, and when the node receives a packet for relaying, checking its processing costs and determining if the node will then transmit a relay packet.

Yet another embodiment of the present invention provides a system, comprising a plurality of nodes capable of cooperating in a distributed communication wireless network, wherein said cooperation is based upon predetermined fairness criteria. Again, the predetermined fairness criteria may include a process that accounts for battery life and quality of service (QoS).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a node capable of cooperating in a distributed communication wireless network; and
wherein said cooperation is based upon predetermined fairness criteria.

2. The apparatus of claim 1, wherein said predetermined fairness criteria includes algorithms that account for battery life and quality of service (QoS).

3. The apparatus of claim 1, wherein said wireless network is a centralized network.

4. The apparatus of claim 1, wherein when said node receives a packet for relaying, it first checks whether its own data needs are met and if said node doesn't have outstanding packets, it then checks its processing costs and determines if said node will then transmits a relay packet.

5. The apparatus of claim 1, wherein said node is capable of receiving a header on a relay packet and determining whether or not to receive a full packet or not.

6. The apparatus of claim 4, wherein said data needs are measured by the length of the application layer packet queue.

7. The apparatus of claim 4, wherein processing costs are measured by a remaining battery power.

8. The apparatus of claim 1, wherein said wireless network is a de-centralized networks.

9. The apparatus of claim 8, wherein said nodes are rewarded for spending battery power to assist other nodes.

10. The apparatus of claim 9, wherein said rewarding is accomplished by incentive based billing methods to accounts associated with said node.

11. The apparatus of claim 10, wherein said incentive based billing methods is performed by one or more of the following methods:
a tiered service plan wherein nodes in said network cooperate with others but do not request cooperation will pay a lowest basic rate;
nodes in said network that do not request cooperation and do not cooperate will be charged a medium rate higher a basic rate;
nodes in said network that cooperate and request cooperation will be charged a medium rate; and
nodes in said network that request cooperation but do not cooperate will be charged a highest premium rate.

12. The apparatus of claim 11, wherein said method is enforced by a vendor or service provider of said network by means of a software switch or activation code.

13. The apparatus of claim 8, wherein the cooperation by said node in said network is encouraged by usage based incentives, wherein nodes that relay the most packets for other nodes receive compensation at the end of a billing period and is implemented by having a final destination gateway keep track of all relaying addresses when it eventually receives the packet.

14. The apparatus of claim 8, wherein the cooperation by said node in said network is encouraged by Usage based points/credits wherein nodes that relay packets for other nodes receive credit points per packet by a local wireless gateway keeping track of packets relayed by each node.

15. A method of node cooperation in a distributed communication wireless network, comprising:
basing cooperation by nodes in said distributed communication wireless network upon predetermined fairness criteria.

16. The method of claim 15, further comprising accounting for battery life and quality of service (QoS) in said predetermined fairness criteria.

17. The method of claim 15, wherein said wireless network is a centralized networks.

18. The method of claim 15, further comprising checking first whether its own data needs are met and if said node doesn't have outstanding packets, and when said node receives a packet for relaying, checking its processing costs and determining if said node will then transmit a relay packet.

19. The method of claim 15, further comprising receiving a header on a relay packet and determining whether or not to receive a full packet or not.

20. The method of claim 15, wherein said wireless network is a de-centralized networks.

21. The method of claim 15, further comprising rewarding said nodes for spending battery power to assist other nodes.

22. The method of claim 21, further comprising using incentive based billing methods to accounts associated with said node.

23. The method of claim 22, wherein said incentive based billing methods is performed by one or more of the following methods:
a tiered service plan wherein nodes in said network cooperate with others but do not request cooperation will pay a lowest basic rate;
nodes in said network that do not request cooperation and do not cooperate will be charged a medium rate higher a basic rate;
nodes in said network that cooperate and request cooperation will be charged a medium rate; and
nodes in said network that request cooperation but do not cooperate will be charged a highest premium rate.

24. The method of claim 15, further comprising encouraging the cooperation by said node in said network by Usage based points/credits wherein nodes that relay packets for other nodes receive credit points per packet by a local wireless gateway keeping track of packets relayed by each node.

25. A system, comprising:
a plurality of nodes capable of cooperating in a distributed communication wireless network, wherein said cooperation is based upon predetermined fairness criteria.

26. The system of claim 25, wherein said predetermined fairness criteria includes algorithms that account for battery life and quality of service (QoS).

27. The system of claim 25, wherein said wireless network is a centralized network.

28. The system of claim 25, wherein said wireless network is a de-centralized network.
